(19) United States
(12) Patent Application Publication
(10) Pub. No.: US 2026/0170849 A1
(43) Pub. Date: Jun. 18, 2026

(54) METHOD FOR FUSING CAMERA AND ULTRASONIC SENSOR DATA, VEHICLE, AND COMPUTER-READABLE STORAGE MEDIUM STORING INSTRUCTIONS FOR PERFORMING METHOD FOR FUSING CAMERA AND ULTRASONIC SENSOR DATA

(71) Applicants: Hyundai Motor Company, Seoul (KR); Kia Corporation, Seoul (KR)

(72) Inventors: Jun Hyung KIM, Hwaseong-Si (KR); Da Ye OH, Hwaseong-Si (KR); Jun Ho KOH, Hwaseong-Si (KR)

(21) Appl. No.: 19/421,307

(22) Filed: Dec. 16, 2025

(30) Foreign Application Priority Data
Dec. 17, 2024 (KR) 10-2024-0189019

(51) Int. Cl. G06V 20/58; B60W 30/095; B60W 60/00; G01S 15/86; G01S 15/931; G06T 7/50; G06V 10/25; G06V 10/44; G06V 10/80

(52) U.S. Cl. CPC G06V 20/58; B60W 30/0956; B60W 60/0015; G01S 15/86; G01S 15/931; G06T 7/50; G06V 10/25; G06V 10/44; G06V 10/806; B60W 2420/403; G06T 2207/30252

(57) ABSTRACT

There is provided a method for fusing camera and ultrasonic sensor data. The method comprises determining ultrasonic data detected by an ultrasonic sensor and generating ultrasonic feature information based on the ultrasonic data; determining image data input through a camera and generating image feature information based on the image data; performing view transformation by reflecting depth information of the image feature information and depth information based on the ultrasonic data and generating ultrasonic guided view-transformed bird's-eye-view (BEV) feature information using the view-transformed data; aligning the ultrasonic feature information based on information on an object included in the image feature information and generating ultrasonic BEV feature information using the aligned ultrasonic feature information; and fusing the ultrasonic guided view-transformed BEV feature information and the ultrasonic BEV feature information.

### CROSS-REFERENCE TO RELATED APPLICATION

This application claims the benefit of priority to Korean Patent Application No. 10-2024-0189019, filed in the Korean Intellectual Property Office on Dec. 17, 2024, the disclosure of which is incorporated herein by reference in its entirety.

### TECHNICAL FIELD

The disclosed disclosure relates to a vehicle and a control method therefor, and more specifically, to sensor fusion technology.

### BACKGROUND

The matters described in this Background section are only for enhancement of understanding of the background of the disclosure, and should not be taken as acknowledgment that they correspond to prior art already known to those skilled in the art.

An autonomous vehicle may recognize a road environment by itself, determine a driving situation, and move from a current position to a target position along a planned driving path.

In this case, the autonomous vehicle may use a sensor fusion device, and the sensor fusion device may allow other vehicles, obstacles, and roads to be recognized through a combination of various sensors such as a camera, radar, and lidar.

To this end, signals or data detected through various sensors may be fused, but since detection distances and characteristics of recognized data may be different depending on types of sensors, various attempts are being performed to fuse signals or data detected through the sensors.

### SUMMARY

Further, since there is ambiguity in information depending on characteristics of the ultrasonic sensor, it is difficult to clearly identify a position of an obstacle, and even when data from an ultrasonic sensor is fused with data from other sensors, usability of information detected from the data of the ultrasonic sensor is low.

The disclosed disclosure is directed to providing a method and a vehicle capable of improving the reliability of camera bird's-eye-view (BEV) feature information by fusing data from an ultrasonic sensor with feature information of an image acquired from a camera.

Further, the disclosed disclosure is directed to providing a method and a vehicle capable of improving the accuracy of feature information based on an ultrasonic sensor by fusing data from an ultrasonic sensor with feature information of an image acquired from a camera, and improving reliability of an object detected from the feature information of the image.

Further, the disclosed disclosure is directed to providing a method and a vehicle capable of solving a problem of a position error that occurs when data from an ultrasonic sensor is accumulated and refining an ambiguous recognition range of the sensor.

Further, the disclosed disclosure is directed to providing a method and a vehicle capable of generating an occupancy map with high object detection performance by utilizing mutual information through early fusion, compared to a late-fusion logic based on individual sensor processing.

Technical problems to be solved in the present disclosure are not limited to the technical problems, which have been mentioned above, and other technical problems that are not mentioned will be clearly understood by those of ordinary skill in the art to which the present disclosure belongs from the following description.

According to the present disclosure, a method performed by a vehicle may comprise obtaining, via an ultrasonic sensor of the vehicle, ultrasonic data; generating, based on the ultrasonic data, ultrasonic feature information; obtaining, via a camera of the vehicle, image data; generating, based on the image data, image feature information; performing, based on first depth information associated with the image feature information and second depth information associated with the ultrasonic data, a view transformation on the image feature information; generating, using the view-transformed image feature information, ultrasonic guided view-transformed bird's-eye-view feature information; adjusting, based on the image feature information, the ultrasonic feature information, wherein the image feature information includes information on an object; generating, using the adjusted ultrasonic feature information, ultrasonic bird's-eye-view feature information; fusing the ultrasonic guided view-transformed bird's-eye-view feature information with the ultrasonic bird's-eye-view feature information to generate fused bird's-eye-view feature information; outputting, based on the fused bird's-eye-view feature information, a signal indicating the object; and controlling, based on the signal, an operation (e.g., autonomous driving) of the vehicle.

Generating the ultrasonic guided view-transformed bird's-eye-view feature information may comprise estimating, based on the image feature information, a depth distribution; performing, based on the estimated depth distribution, a view transformation on the image feature information to generate first bird's-eye-view feature information; determining, based on the ultrasonic data, the second depth information; performing, based on the second depth information, a view transformation on the ultrasonic feature information to generate second bird's-eye-view feature information; and generating the ultrasonic guided view-transformed bird's-eye-view feature information by fusing the first bird's-eye-view feature information with the second bird's-eye-view feature information.

Generating the ultrasonic feature information may comprise determining a plurality of pieces of ultrasonic data detected via the ultrasonic sensor at different times, performing compensation on each of the plurality of pieces of ultrasonic data with reference to one of the different times, and accumulating the plurality of compensated pieces of ultrasonic data to generate the ultrasonic feature information.

Accumulating the plurality of compensated pieces of ultrasonic data may be based on the image feature information including the object, and generating the ultrasonic bird's-eye-view feature information may comprise adjusting an area corresponding to the object that is included in the adjusted ultrasonic feature information.

Further operations may comprise determining, based on encoding the ultrasonic guided view-transformed bird's-eye-view feature information, bird's-eye-view feature information to generate bird's-eye-view object information by distinguishing a bird's-eye-view object using the bird's-eye-view feature information, and generating obstacle boundary information by detecting an obstacle boundary using the bird's-eye-view feature information, wherein distinguishing the bird's-eye-view object may comprise distinguishing the bird's-eye-view object using the obstacle boundary information, and wherein detecting the obstacle boundary may comprise detecting the obstacle boundary using the bird's-eye-view object information.

Further operations may comprise determining, based on encoding the ultrasonic guided view-transformed bird's-eye-view feature information, bird's-eye-view feature information to generate bird's-eye-view object information by distinguishing a bird's-eye-view object using the bird's-eye-view feature information, fusing the bird's-eye-view object information with the bird's-eye-view feature information, and generating obstacle boundary information by detecting an obstacle boundary using the bird's-eye-view feature information fused with the bird's-eye-view object information.

Further operations may comprise generating, based on bird's-eye-view segmentation information and obstacle-boundary information obtained from the fused bird's-eye-view feature information, an occupancy map representing object-occupied regions and unoccupied regions in a surrounding environment of the vehicle, obtaining, from the occupancy map, outline information of the object, and performing, based on the outline information, interpolation on the ultrasonic data.

According to the present disclosure, a vehicle may comprise a sensor unit configured to detect a target object present in a surrounding environment of the vehicle during autonomous driving of the vehicle, wherein the sensor unit may comprise a camera and an ultrasonic sensor; a processor; and a memory storing at least one instruction that, when executed by the processor, is configured to cause the vehicle to obtain, via the ultrasonic sensor, ultrasonic data; generate, based on the ultrasonic data, ultrasonic feature information; obtain, via the camera, image data; generate, based on the image data, image feature information; perform, based on first depth information associated with the image feature information and second depth information associated with the ultrasonic data, a view transformation on the image feature information; generate, using the view-transformed image feature information, ultrasonic guided view-transformed bird's-eye-view feature information; adjust, based on the image feature information, the ultrasonic feature information, wherein the image feature information includes information on an object; generate, using the adjusted ultrasonic feature information, ultrasonic bird's-eye-view feature information; fuse the ultrasonic guided view-transformed bird's-eye-view feature information with the ultrasonic bird's-eye-view feature information to generate fused bird's-eye-view feature information; output, based on the fused bird's-eye-view feature information, a signal indicating the object; and control, based on the signal, an operation of the vehicle.

Operations may comprise estimating, based on the image feature information, a depth distribution, performing, based on the estimated depth distribution, a view transformation on the image feature information to generate first bird's-eye-view feature information, determining, based on the ultrasonic data, the second depth information, performing, based on the second depth information, a view transformation on the ultrasonic feature information to generate second bird's-eye-view feature information, and generating the ultrasonic guided view-transformed bird's-eye-view feature information by fusing the first bird's-eye-view feature information with the second bird's-eye-view feature information.

Operations may comprise determining a plurality of pieces of ultrasonic data detected via the ultrasonic sensor at different times, performing compensation on each of the plurality of pieces of ultrasonic data with reference to one of the different times, and accumulating the plurality of compensated pieces of ultrasonic data to generate the ultrasonic feature information.

Operations may comprise determining, based on the image feature information including the object, the plurality of compensated pieces of ultrasonic data, and adjusting an area corresponding to the object that is included in the adjusted ultrasonic feature information.

Operations may comprise determining, based on encoding the ultrasonic guided view-transformed bird's-eye-view feature information, bird's-eye-view feature information to generate bird's-eye-view object information by distinguishing a bird's-eye-view object using the bird's-eye-view feature information, and generating obstacle boundary information by detecting an obstacle boundary using the bird's-eye-view feature information, wherein distinguishing the bird's-eye-view object may comprise distinguishing the bird's-eye-view object using the obstacle boundary information, and wherein detecting the obstacle boundary may comprise detecting the obstacle boundary using the bird's-eye-view object information.

Operations may comprise determining, based on encoding the ultrasonic guided view-transformed bird's-eye-view feature information, bird's-eye-view feature information to generate bird's-eye-view object information by distinguishing a bird's-eye-view object using the bird's-eye-view feature information, fusing the bird's-eye-view object information with the bird's-eye-view feature information, and generating obstacle boundary information by detecting an obstacle boundary using the bird's-eye-view feature information fused with the bird's-eye-view object information.

Operations may comprise generating, based on bird's-eye-view segmentation information and obstacle-boundary information obtained from the fused bird's-eye-view feature information, an occupancy map representing object-occupied regions and unoccupied regions in the surrounding environment of the vehicle, obtaining, from the occupancy map, outline information of the object, and performing, based on the outline information, interpolation on the ultrasonic data.

According to the present disclosure, a non-transitory computer-readable storage medium may store instructions that, when executed, cause a vehicle to obtain, via an ultrasonic sensor, ultrasonic data; generate, based on the ultrasonic data of the vehicle, ultrasonic feature information; obtain, via a camera of the vehicle, image data; generate, based on the image data, image feature information; perform, based on first depth information associated with the image feature information and second depth information associated with the ultrasonic data, a view transformation on the image feature information; generate, using the view-transformed image feature information, ultrasonic guided view-transformed bird's-eye-view feature information;

adjust, based on the image feature information, the ultrasonic feature information, wherein the image feature information includes information on an object; generate, using the adjusted ultrasonic feature information, ultrasonic bird's-eye-view feature information; fuse the ultrasonic guided view-transformed bird's-eye-view feature information with the ultrasonic bird's-eye-view feature information to generate fused bird's-eye-view feature information;

output, based on the fused bird's-eye-view feature information, a signal indicating the object; and control, based on the signal, autonomous driving of the vehicle.

Operations may comprise estimating, based on the image feature information, a depth distribution, performing, based on the estimated depth distribution, a view transformation on the image feature information to generate first bird's-eye-view feature information, determining, based on the ultrasonic data, the second depth information, performing, based on the second depth information, a view transformation on the ultrasonic feature information to generate second bird's-eye-view feature information, and generating the ultrasonic guided view-transformed bird's-eye-view feature information by fusing the first bird's-eye-view feature information with the second bird's-eye-view feature information.

Operations may comprise determining a plurality of pieces of ultrasonic data detected via the ultrasonic sensor at different times, performing compensation on each of the plurality of pieces of ultrasonic data with reference to one of the different times, and accumulating the plurality of compensated pieces of ultrasonic data to generate the ultrasonic feature information.

Operations may comprise accumulating the plurality of compensated pieces of ultrasonic data based on the image feature information including the object, and generating the ultrasonic bird's-eye-view feature information by adjusting an area corresponding to the object that is included in the adjusted ultrasonic feature information.

Operations may comprise determining, based on encoding the ultrasonic guided view-transformed bird's-eye-view feature information, bird's-eye-view feature information to generate bird's-eye-view object information by distinguishing a bird's-eye-view object using the bird's-eye-view feature information, and generating obstacle boundary information by detecting an obstacle boundary using the bird's-eye-view feature information, wherein distinguishing the bird's-eye-view object may comprise distinguishing the bird's-eye-view object using the obstacle boundary information, and wherein detecting the obstacle boundary may comprise detecting the obstacle boundary using the bird's-eye-view object information.

Operations may comprise determining, based on encoding the ultrasonic guided view-transformed bird's-eye-view feature information, bird's-eye-view feature information to generate bird's-eye-view object information by distinguishing a bird's-eye-view object using the bird's-eye-view feature information, fusing the bird's-eye-view object information with the bird's-eye-view feature information, and generating obstacle boundary information by detecting an obstacle boundary using the bird's-eye-view feature information fused with the bird's-eye-view object information.

The advantages and effects attainable through the present disclosure are not limited to those expressly recited above. Additional advantages and effects, which have not been explicitly mentioned, will be apparent to, and readily appreciated by, those of ordinary skill in the art to which the present disclosure pertains from the following description.

### BRIEF DESCRIPTION OF THE DRAWINGS

The above and other objects, features and advantages of the present disclosure will become more apparent to those of ordinary skill in the art by describing examples thereof in detail with reference to the accompanying drawings, in which:

FIG. 1 shows an example that a vehicle transmits and receives data by communicating with another device;

FIG. 2 shows exemplary modules constituting a vehicle;

FIG. 3 shows an example of a detailed configuration of a processor and a memory for autonomous driving control in an autonomous driving device;

FIG. 4 shows an example of a configuration unit for processing sensor fusion of the image signal processing module and the ultrasonic signal processing module;

FIG. 5 shows an example of an operation of an ultrasonic guided view transformation unit performing ultrasonic-based view transformation of the FIG. 4;

FIG. 6 shows an example of an image-guided ultrasonic edge-aligned feature map used in an operation for processing sensor fusion of the image signal processing module and the ultrasonic signal processing module;

FIG. 7 shows an example of an ultrasonic refined FOV (Field of View) used in an operation for processing sensor fusion of the image signal processing module and the ultrasonic signal processing module;

FIG. 8 shows an example of a detailed configuration of the sensor fusion unit of FIG. 4;

FIG. 9 shows another example of a detailed configuration of the sensor fusion unit of FIG. 4;

FIG. 10 shows an example of an emphasized occupancy map used in an operation for processing sensor fusion of the image signal processing module and the ultrasonic signal processing module;

FIG. 11 shows an example of an operation of a method for fusing camera and ultrasonic sensor information; and

FIG. 12 shows an example computing system.

### DETAILED DESCRIPTION

The advantages and features of the examples and the methods of accomplishing the examples will be clearly understood from the following description taken in conjunction with the accompanying drawings. However, examples are not limited to those examples described, as examples may be implemented in various forms. It should be noted that the present examples are provided to make a full disclosure and to allow those skilled in the art to know the full range of the examples. Therefore, the examples are to be defined only by the scope of the appended claims.

Terms used in the present specification will be briefly described, and the present disclosure will be described in detail.

In terms used in the present disclosure, general terms currently as widely used as possible while considering functions in the present disclosure are used. However, the terms may vary according to the intention or precedent of a technician working in the field, the emergence of modern technologies, and the like. In addition, in certain cases, there are terms arbitrarily selected by the applicant, and in this case, the meaning of the terms will be described in detail in the description of the corresponding disclosure. Therefore, the terms used in the present disclosure should be defined based on the meaning of the terms and the overall contents of the present disclosure, not just the name of the terms.

When it is described that a part in the overall specification “includes” a certain component, this means that other components may be further included instead of excluding other components unless specifically stated to the contrary.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all combinations of the listed items. For example, “at least one of A or B” may refer to (1) at least one A; (2) at least one B; or (3) at least one A and at least one B.

The term “module,” “unit,” or “portion” used in the specification means a software and/or hardware component, and the “module,” “unit,” or “portion” performs certain operations/functions/roles. However, the “module,” “unit,” or “portion” is not construed as being limited to software or hardware. The “module,” “unit,” or “portion” may be configured to be in an addressable storage medium or to execute one or more processors. Therefore, as an example, the “module,” “unit,” or “portion” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium to be executed on a computer. The medium may either continuously store a computer-executable program or temporarily store the program for execution or download. Furthermore, the medium may be a variety of recording or storage means in the form of a single hardware device or multiple combined hardware devices and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control settings (e.g., an autonomous driving classification or selection of an autonomous driving level for a vehicle). Based on a feature of depth-guided BEV generation via camera-ultrasonic fusion described herein, an operation of the vehicle may be controlled. For example, when the fused BEV occupancy map indicates close lateral obstacles or uncertain depth regions, the autonomous driving control may reduce speed, adjust lateral position, or delay lane-change execution to maintain safety. When the fusion output identifies clear and stable surroundings, the system may increase autonomous driving level or extend control range to enhance driving comfort and efficiency.

One or more auxiliary devices (e.g., an engine brake, exhaust brake, hydraulic retarder, electric retarder, or regenerative brake) may also be controlled, for example, based on a feature of depth-guided BEV generation via camera-ultrasonic fusion. For instance, when the fused BEV occupancy map detects a close obstacle or descending slope, the processor may activate a regenerative brake or exhaust brake to slow the vehicle while maintaining stability. When the fusion data indicates a flat, obstacle-free surface, the auxiliary braking force may be reduced to improve energy efficiency. In another example, when the camera-ultrasonic fusion output identifies uneven terrain or a steep curve, an electric retarder may be selectively engaged to provide smoother deceleration control.

One or more communication devices (e.g., a modem, network adapter, radio transceiver, or antenna) may also be controlled, for example, based on a feature of depth-guided BEV generation via camera-ultrasonic fusion. For instance, when the fused BEV occupancy map detects obstacles or irregular terrain around the vehicle, the processor may increase transmission frequency of V2X messages to alert nearby vehicles or infrastructure of the detected condition. When the fusion data identifies a clear and stable surrounding area, the communication device may reduce data transmission or switch to a low-power communication mode to conserve energy. In another example, when the BEV fusion output indicates imminent proximity to another connected vehicle, the system may trigger direct short-range communication to coordinate avoidance or parking maneuvers.

Minimum Risk Maneuver (MRM) operations may also be controlled, for example, based on a feature of depth-guided BEV generation via camera-ultrasonic fusion. For instance, when the fused BEV occupancy map detects close-range obstacles or narrowed lane boundaries, the processor may automatically initiate a minimum-risk deceleration and lateral adjustment to guide the vehicle to a safe stop. When the fusion data indicates open space at the roadside or shoulder area, the MRM control may steer the vehicle toward the safest available zone and stop smoothly. In another example, when the BEV fusion identifies inconsistent or missing depth information caused by sensor degradation, the system may enter a minimal-risk mode, maintaining low-speed straight-line travel while signaling for driver takeover.

Biased driving operations may also be controlled, for example, based on a feature of depth-guided BEV generation via camera-ultrasonic fusion. For instance, when the fused BEV occupancy map indicates an object intruding near a lane boundary, the driving control apparatus may apply a lateral bias to maintain a safer distance from the detected obstacle. When the fusion result identifies a shallow roadside structure or curb, the apparatus may slightly offset the vehicle's position within the lane to minimize collision risk. Conversely, when no close-range obstacle is detected in the fused BEV map, the vehicle may return to a lane-centered trajectory for smoother travel. In another example, if the ultrasonic fusion data shows irregular ground height or pooling water, the biased driving control may adjust lateral positioning to avoid the affected region while maintaining overall stability and comfort.

One or more sensors (e.g., IMU sensors, cameras, LIDAR, RADAR, ultrasonic sensors, blind spot monitoring sensors, or parking sensors, etc.) may also be controlled, for example, based on a feature of depth-guided BEV generation via camera-ultrasonic fusion.

For instance, when the fused BEV feature information indicates degraded near-field perception (e.g., excessive reflection or weak ultrasonic response), the system may adjust the sensitivity or refresh rate of the ultrasonic sensor and nearby cameras to improve detection. When the fused BEV occupancy map identifies inconsistent depth continuity, the vehicle may recalibrate sensor alignment or increase sampling frequency for affected sensors. Conversely, when the fusion result confirms stable depth estimation and reliable object boundaries, the processor may reduce redundant sensor polling to conserve energy while maintaining accurate perception for autonomous driving control.

An autonomous driving level and/or autonomous driving activation or deactivation may also be controlled based on a feature of depth-guided BEV generation via camera-ultrasonic fusion. For example, when the fused BEV map indicates degraded near-field perception (e.g., due to rain, surface reflection, or sensor occlusion), the processor may lower the autonomous driving level or prompt the driver to take partial control. Conversely, when the fused BEV data shows stable detection of close-range obstacles and lane boundaries, the vehicle may activate or maintain a higher autonomous driving mode. In another example, when the BEV occupancy map exhibits irregular depth discontinuities or sparse ultrasonic returns, the system may temporarily deactivate autonomous driving and display a warning on the screen until consistent fused data is restored.

According to the present disclosure, a method and system are provided for enhancing environmental perception of a vehicle by fusing data obtained from a camera and an ultrasonic sensor. Differences in detection range and data characteristics among sensors may make it difficult to achieve consistent recognition performance. The present disclosure provides a configuration that generates a bird's-eye-view (BEV) feature map integrating visual and ultrasonic information. Image data acquired by the camera may be transformed into a BEV feature map by reflecting short-range depth information accumulated from ultrasonic signals.

In parallel, ultrasonic data may be aligned and refined based on object boundaries identified from the camera image to produce an image-guided ultrasonic BEV feature map. The two BEV feature maps may then be fused to construct a weighted occupancy map that emphasizes object edges and depth information. This fusion enables improved reliability and accuracy of object recognition, reduction of positional errors in ultrasonic data, and generation of a high-precision occupancy map for stable vehicle control in autonomous driving.

Hereinafter, the example of the present disclosure will be described in detail with reference to the accompanying drawings so that those of ordinary skill in the art may easily implement the present disclosure. In the drawings, portions not related to the description are omitted to clearly describe the present disclosure.

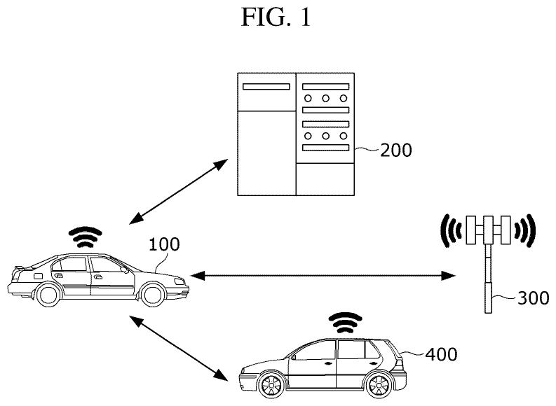

FIG. 1 shows an example that a vehicle transmits and receives data by communicating with another device.

Referring to FIG. 1, the vehicle 100 may be driven based on electric energy or fossil energy. In the case of electric energy, the vehicle 100 may adopt a pure battery-based vehicle driven solely by a high-voltage battery or a gas-based fuel cell as an energy source. The fuel cell may utilize various types of gases capable of generating electric energy, and the gas may be filled in the vehicle 100 in a liquefied state. For instance, the gas may be hydrogen (e.g., ammonia, methane, or natural gas, etc.), but various other gases may also be applicable. In the case of fossil energy, the vehicle 100 may be driven based on fuels such as gasoline, diesel, or liquefied gas (e.g., LPG, LNG, bio-diesel, or synthetic e-fuel, etc.), and it may be equipped with an internal combustion engine that drives an actuator 116 by burning the fuel. The engine may be included in an energy generator 110 in terms of providing rotational driving force to the wheel driver 118. As another example, the vehicle 100 may be a hybrid type vehicle selectively utilizing the energy of a fossil fuel-based internal combustion engine and an electric battery to drive the actuating unit 116 (e.g., a plug-in hybrid, mild hybrid, or range-extended electric vehicle, etc.).

The vehicle 100 may refer to a movable device. The vehicle 100 may be a ground vehicle, such as a typical passenger or commercial vehicle, or a purpose-built vehicle (PBV) for specific purposes (e.g., delivery, ride-sharing, shuttle, or rescue, etc.). The vehicle 100 may be a four-wheeled vehicle, such as a passenger car, SUV, or small truck, or a vehicle with more than four wheels, such as a bus, large truck, container carrier, or heavy equipment (e.g., an excavator, dump truck, or airport tug, etc.). The vehicle 100 may also be a robot in the broad sense of a movable means, and the robot may move using wheels, tracks, or other mobility modules (e.g., crawler tracks, omni-directional wheels, or robotic legs, etc.).

The vehicle 100 may be controlled and driven autonomously, and autonomous driving may be implemented as semi-autonomous driving or fully autonomous driving. Fully autonomous driving may be provided as autonomous movement in which the processor 122 of the vehicle 100 fully controls the driving without user intervention, even in uncertain driving conditions (e.g., poor visibility, heavy rain, or unmarked roads, etc.). Semi-autonomous driving may be provided as autonomous movement that requires driver intervention in specific driving situations (e.g., construction zones, high-traffic intersections, or system-diagnostic conditions, etc.). Semi-autonomous driving may be implemented to enable manual driving by transferring control to the user when the processor 122 deactivates autonomous driving upon occurrence of such situations. According to the autonomous driving levels defined by the Society of Automotive Engineers (SAE), semi-autonomous driving may correspond to levels 1 to 4, and fully autonomous driving may correspond to level 5.

Meanwhile, the vehicle 100 may perform communication with other devices 200, 300, or other vehicles 400. The other devices may include, for example, a server 200 supporting various control state management and driving of the vehicle 100, an Intelligent Transportation System (ITS) device 300 for receiving information from ITS, and various types of user devices (e.g., smartphones, tablets, wearable devices, or smart keys, etc.). The server 200 may be an external device operated by a vehicle manufacturer or prepared to provide autonomous driving services and may transmit or receive connected data necessary for autonomous driving to or from the vehicle 100. The server 200 may transmit various information and software modules used for the control of the vehicle 100 in response to requests and data transmitted from the vehicle 100 and user devices to support autonomous driving and various services of the vehicle 100 (e.g., navigation updates, firmware downloads, or route-planning data, etc.).

The ITS device 300, for instance, may be a Road Side Unit (RSU). The ITS device 300 may exchange vehicle perception data, driving control and state data, environmental data around the vehicle, and map data with the vehicle 100 through Vehicle-to-Infrastructure (V2I) communication (e.g., data on traffic lights, speed limits, or road hazards, etc.) to assist the user's driving or support autonomous driving of the vehicle 100. The vehicle 100 may support manual or autonomous driving by exchanging the aforementioned data with other vehicles 400 through Vehicle-to-Vehicle (V2V) communication (e.g., for platooning, lane-merge coordination, or collision-avoidance signaling, etc.).

The vehicle 100 may perform communication with other vehicles or devices based on cellular communication, Wireless Access in Vehicular Environment (WAVE) communication, Dedicated Short Range Communication (DSRC), or other communication methods (e.g., Bluetooth, Ultra-Wideband (UWB), or satellite links, etc.). For instance, the vehicle 100 may use communication networks such as LTE or 5G, WiFi networks, or WAVE networks for communication with the server 200, ITS device 300, and other vehicles 400. In another example, DSRC used in the vehicle 100 may be utilized for inter-vehicle communication. The communication methods among the vehicle 100, the server 200, the ITS device 300, other vehicles 400, and user devices are not limited to the above-described examples.

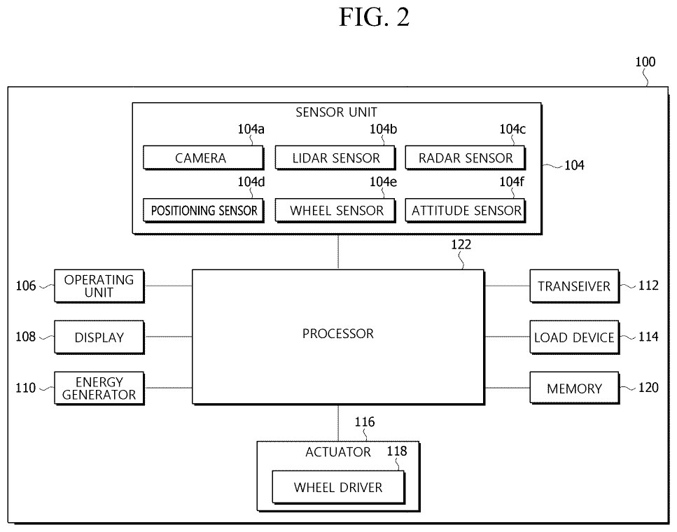

FIG. 2 shows exemplary modules constituting a vehicle according to one example of the present disclosure.

The vehicle 100 may include a sensor unit 102, an operating unit 106, a display 108, a load device 114, and a transceiver 112.

The sensor unit 102 may be equipped with various types of detectors to sense various states and situations occurring in the external environment, internal system, user operations, and passenger space of the vehicle 100 (e.g., ambient-temperature sensors, rain sensors, or cabin-occupancy sensors, etc.). Specifically, the sensor unit 102 may include external-facing cameras 104a, LIDAR sensors 104b, radar sensors 104c, and the like to recognize dynamic and static objects existing outside the vehicle 100. The camera 104a may recognize external objects as images during the use of the vehicle 100, generate image data, and transmit the image data to the processor 122 (e.g., front, rear, side, or surround-view cameras, etc.). The LIDAR sensor 104b may generate point cloud data as recognized data of external objects to generate three-dimensional spatial information identifying the shape of at least the external objects and transmit the point cloud data to the processor 122. The radar sensor 104c may generate radar data by emitting radio waves of a specific frequency around the vehicle 100 and recognizing the external objects through the reflected radio waves to identify the presence, relative distance, speed, and direction of external objects (e.g., other vehicles, pedestrians, or roadside obstacles, etc.). Although the present disclosure illustrates including the LIDAR sensor 104b, it may not be included in other examples.

The sensor unit 102 may include positioning sensor 104d, wheel sensor 104e, and attitude sensor 104f to confirm its position, speed, and driving posture. The attitude sensor 104f may include a gyro sensor, angular velocity sensor, accelerometer, and the like (e.g., a 3-axis accelerometer, gyroscope, or IMU module, etc.).

In the present disclosure, the sensor unit 102 includes sensors mainly referenced in the description of the examples but may further include sensors detecting various situations not listed herein (e.g., tire-pressure sensors, battery-temperature sensors, or occupant-monitoring cameras, etc.).

The operating unit 106 may be configured as a module for user control for driving. For instance, the operating unit 106 may include a steering wheel for manual driving, an automatic or manual transmission actuator, an accelerator pedal, a brake pedal, a gearbox, or a drive-mode selector (e.g., eco, comfort, or sport mode, etc.). The operating unit 106 may further include an interface for the use/deactivation of the autonomous driving mode requested by the user and the selection of detailed function to utilize the autonomous driving function (e.g., lane-keeping, adaptive cruise, or auto-parking, etc.). The operating unit 106 may be configured as a hard-type interface provided at a predetermined position inside the vehicle 100 or a soft-type interface touchable on the display 108 to receive various requests related to autonomous driving.

The display 108 may function as a user interface. The display 108 may display the operation state, control state, route/traffic information, remaining energy information, and contents requested by the driver of the vehicle 100 as controlled by the processor 122 (e.g., maps, alerts, vehicle diagnostics, or entertainment content, etc.). The display 108 may also receive driver's requests instructing the processor 122 by being configured as a touch screen detecting driver input (e.g., tap, swipe, or gesture input, etc.).

The load device 114 may be mounted on the vehicle 100 and be a kind of electric device for non-driving use, excluding the driving power system such as the wheel driver 118. The load device 114 may be an auxiliary device supplied with power from the energy generator 110, such as an air conditioning system, lighting system, seat system, and various devices installed in the vehicle 100 (e.g., infotainment system, power windows, or heated-seat modules, etc.).

The transceiver 112 may support mutual communication with the server 200, ITS device 300, and surrounding vehicles 400. The transceiver 112 may include modules handling cellular communication, WAVE, DSRC communication, or other wireless methods (e.g., Bluetooth, Wi-Fi, or satellite-based links, etc.). For instance, the transceiver 112 may transmit data generated or stored during driving to the server 200 and receive data and software modules transmitted from the server 200 (e.g., firmware updates, map data, or driving-policy modules, etc.). The transceiver 112 may also support communication with electronic devices carried by passengers inside the vehicle 100 (e.g., smartphones, tablets, or wearable devices, etc.). In the present disclosure, the vehicle 100 may transmit and receive data utilized in the methods according to the present disclosure through the transceiver 112.

The vehicle 100 may also include an energy generator 110 and an actuating unit 116.

The energy generator 110 may generate and supply power and electricity used in the driving power system, such as the actuating unit 116, and the non-driving power system. The non-driving power system may include, for example, the sensor unit 102, operating unit 106, display 108, load device 114, transceiver 112, and the like, and may include various components implementing sensing, interface, communication, and convenience functions, excluding components directly involved in driving operations (e.g., infotainment, air conditioning, or power windows, etc.). When the vehicle 100 is driven based on electric energy, the energy generator 110 may be configured as an electric battery charged from an external source or a combination of an electric battery and a fuel cell charging the battery (e.g., lithium-ion, solid-state, or nickel-metal-hydride batteries, etc.). In the case of a combination of an electric battery and a fuel cell, the energy generator 110 may include a tank storing a material, such as liquefied hydrogen, used to generate power in the fuel cell (e.g., hydrogen, ammonia, or methanol-based fuel, etc.). When the vehicle 100 is driven based on fossil energy, the energy generator 110 may be configured as an internal combustion engine (e.g., gasoline, diesel, or LPG engine, etc.). Additionally, when the vehicle 100 is of a hybrid type, the energy generator 110 may be provided as a combination of an internal combustion engine and an electric battery (e.g., parallel hybrid or series hybrid type, etc.).

The actuator 116 may include at least one module implementing driving operations and may perform at least one of longitudinal control, such as acceleration and deceleration, and lateral control, such as steering, based on user requests from the operating unit 106. The actuator 116 may include mechanical components and electronic modules implementing driving operations in the wheel driver 118 to perform driving operations according to commands of the processor 122 for manual control or autonomous driving. When the vehicle 100 is operated based on electric energy, it may include an assembly for delivering the requested driving operations to the wheel driver 118 (e.g., an inverter, motor controller, or reduction gear, etc.). When the vehicle 100 is operated based on fossil energy, the actuator 116 may include a transmission gear module delivering the power of the internal combustion engine (e.g., automatic transmission, CVT, or dual-clutch gearbox, etc.).

The wheel driver 118 may include a driving force generating module generating driving force for multiple wheels or transferring driving force to the wheels, a braking module decelerating the driving of the wheels, and a steering module realizing lateral control of the wheels (e.g., rack-and-pinion, steer-by-wire, or rear-wheel steering, etc.). When the vehicle 100 is driven based on electric energy, the driving force generating module may be configured as a motor assembly generating driving force based on the power output from the electric battery (e.g., hub motor, front-motor, or dual-motor drive, etc.). The braking module of the electric-based vehicle 100 may further have a regenerative braking function (e.g., energy recovery during deceleration or downhill driving, etc.).

In addition, the vehicle 100 may include a memory 120 and a processor 122.

The memory 120 may store applications and various data for controlling the vehicle 100, and load applications or read and record data by a request of the processor 122. In the present disclosure, the memory 120 may store an application and at least one instruction for determining a traffic congestion situation for a driving area of the autonomous vehicle 100 and generating congestion control information based on the traffic congestion situation (e.g., identifying slow-speed areas, blocked lanes, or high-density intersections, etc.). In addition, the memory 120 may generate final longitudinal control information based on various data including congestion control information and hold applications and instructions for controlling the vehicle 100 in the traffic congestion situation according to the information (e.g., adjusting speed, maintaining gap distance, or optimizing acceleration, etc.).

The longitudinal control may be control related to a speed, an acceleration, and a relative distance to a surrounding vehicle of the vehicle 100. As one example, the longitudinal control may be motion control in autonomous driving (e.g., cruise control, stop-and-go control, or adaptive following, etc.). As another example, the longitudinal control may be used in manual driving as well as autonomous driving. When there is a manual operation that is different from an operation appropriate for the surrounding situation, the processor 122 may intervene in manual driving with the longitudinal control that matches the surrounding situation, or may provide longitudinal control-related data to a manual driver (e.g., issuing haptic feedback, alert messages, or automatic speed adjustments, etc.).

Accordingly, as one example, the longitudinal control information may include a speed and an acceleration applied to the vehicle 100. The speed and the acceleration may be generated as longitudinal data that applies to any one of a time range, a distance range, or a specific section along a route (e.g., a 10-second period, a 200-meter stretch, or an exit ramp section, etc.). The longitudinal control information may be described as profiles of continuous velocity and acceleration over the range or section. As another example, in addition to the speed and the acceleration, the longitudinal control information may further include control factors applied to the vehicle 100, for example, control according to a relative required distance to surrounding vehicles (e.g., time gap, braking buffer, or following distance, etc.).

The memory 120 may manage road information, surrounding object information, and vehicle information to generate final longitudinal control information depending on the presence or absence of the traffic congestion situation.

The road information may include lane level route information, road restriction information, a road structure, a traffic sign information, and road event information related to the driving lane in which the vehicle 100 moves and surrounding lanes (e.g., construction zones, ramps, or merging lanes, etc.). In the present disclosure, the road on which the vehicle 100 moves may have a plurality of lanes and may specifically include a driving lane on which the vehicle 100 travels and surrounding lanes near the driving lane. The lane level route information may be obtained from lane images or map information acquired from, for example, the camera 104a. The map information is, for example, a lane-level precision map, and may be obtained from an external device such as the server 200 and managed in the memory 120. The lane level route information may include a trajectory (or route) of each lane, its width, parameters applied to functions related to each lane, and the like (e.g., curvature, lane marking type, or road-surface gradient, etc.). The road restriction information may be a speed limit required on the road on which the vehicle 100 is traveling and a vehicle behavior required to comply with regulations related to the corresponding road (e.g., restricted lanes, toll zones, or speed-reduction areas, etc.). The traffic sign information may be information related to traffic control and guidance displayed on a road surface and signs installed on the road. The traffic sign information may include, for example, crosswalks, stop lines, U-turns, left turns, speed limits, milestones, and the like (e.g., no-entry zones, pedestrian-only areas, or temporary roadblocks, etc.).

The road structure may be related to a road shape. The road structure may include information representing, for example, the number of lanes, a road geometry such as a straight or curved line, a road merging section, a road branch section, a road gradient, a tunnel section, road three-dimensionality (e.g., a ground road and an elevated road), and the like (e.g., elevated bridge, underpass, or ramp slope, etc.). The road event information may be information related to an event on the road. The road event information may include, for example, a construction zone, road event information, and a slow-speed section due to severe weather (e.g., heavy rain, snow, or fog, etc.).

The surrounding object information may include data related to the behavior of dynamic objects around the vehicle 100. The surrounding object information is behavior data derived by analyzing dynamic objects obtained from at least one of the sensor unit 102, the intelligence transportation system (ITS) device 300, and other vehicles 400 by the processor 122, and the behavior data may be managed in the memory 120. Dynamic objects may be, for example, surrounding vehicles, pedestrians, or other types of mobility, and other types of mobility may be personal mobility such as bicycles or electric scooters (e.g., e-bikes, e-kickboards, or wheelchairs, etc.). The behavior of the dynamic object may include information related to the position, speed, motion, or the like, of the dynamic object (e.g., acceleration pattern, lane change, or braking behavior, etc.). The speed may include, for example, the speed of each surrounding vehicle and the average speed of surrounding vehicles in a predetermined area. The motion may be defined based on a movement pattern of the dynamic object. Taking a vehicle as an example, the motion may be referred to as a driving motion of the vehicle, and the driving motion may be divided into lane keeping driving and biased driving. The lane keeping driving may be a motion in which surrounding vehicles travel along center areas of their own lanes without deviating from the lanes, thereby causing no interference with the driving of the host vehicle traveling in the adjacent lane. The bias driving may be a motion in which a surrounding vehicle does not deviate from its own lane, but travels eccentrically from the center area and approaches the driving lane used by the host vehicle or some of surrounding vehicles deviate from their own lanes and enter the lane of the host vehicle, thereby causing interference with the driving of the host vehicle (e.g., sudden lane drifts, partial encroachments, or unintentional weaving, etc.).

The vehicle information may refer to information related to the vehicle according to an example of the present disclosure. The vehicle information may include data related to a longitudinal state of the vehicle 100, a sensing detection range of the surrounding environment of the sensor unit 102 mounted on the vehicle 100, and autonomous driving control. The longitudinal state may include a driving lane, a position, a speed, an acceleration, and a distance to a surrounding vehicle of the vehicle 100, and may be acquired by the camera 104a, the positioning sensor 104d, the wheel sensor 104e, the attitude sensor 104f, the radar sensor 104c, and the like, and managed in the memory 120. The sensing detection range may be a distance and an area detected by the detection performance of the sensor unit 102 that varies depending on the road shape, weather, or the like (e.g., reduced range in fog, rain, or steep gradients, etc.). The road shape and weather may be confirmed by road information, surrounding situations detected by the sensor unit 102, and external information provided by the server 200 or the like. Specifically, the detection range of the camera 104a, the LIDAR sensor 104b, and the radar sensor 104c varies depending on a gradient of a front road and the weather, and the variable detection range may be managed in the memory 120 as the sensing detection range. As another example, the detection range according to the gradient and weather may be stored in the memory 120 in a pre-tabulated form (e.g., lookup tables for fog density, slope angle, or light level, etc.).

The data related to autonomous driving control may include a control plan according to various driving situations of the vehicle 100. Here, the driving situation may be, for example, evasive driving, following a preceding vehicle, changing lanes, driving at an intersection, or the like (e.g., merging, overtaking, or parking, etc.). In the present disclosure, the data may be described mainly in terms of a control plan (or an action plan) related to control transfer from autonomous driving to manual driving among various driving situations but is not limited thereto. The action plan may be a plan to reduce instability due to the control transfer, that is, the risk of autonomous driving. When a driving situation that the processor 122 cannot handle occurs, the action plan related to the control transfer may include, for example, a control to notify a user of the transfer in advance and move the vehicle 100 to a safe area on the road at a specific speed and stop the vehicle 100 when the user does not operate the vehicle 100 for a specified period of time after the notification (e.g., pulling over to a shoulder, reducing speed to a stop, or activating hazard lights, etc.). The transfer-related action plan is not limited to the above-described examples and may be established using various methods and speeds (e.g., deceleration ramp control, timed alerts, or cooperative takeover, etc.).

The map information stored in the memory 120 may be used to generate a driving route set in the vehicle 100 by the request of the user or the processor 122. In addition, the map information is utilized for autonomous driving and may include a low-precision map or include a high-precision map together with the map (e.g., GPS-based map, HD lane map, or crowd-sourced road database, etc.). The map information may be provided to have various information and data included in driving environment information.

The processor 122 may perform overall control of the vehicle 100. The processor 122 may be configured to execute applications and instructions stored in the memory 120 (e.g., sensor fusion algorithms, path-planning logic, or control-law execution, etc.).

Hereinafter, a detailed configuration of a processor and a memory for autonomous driving control of a vehicle will be described.

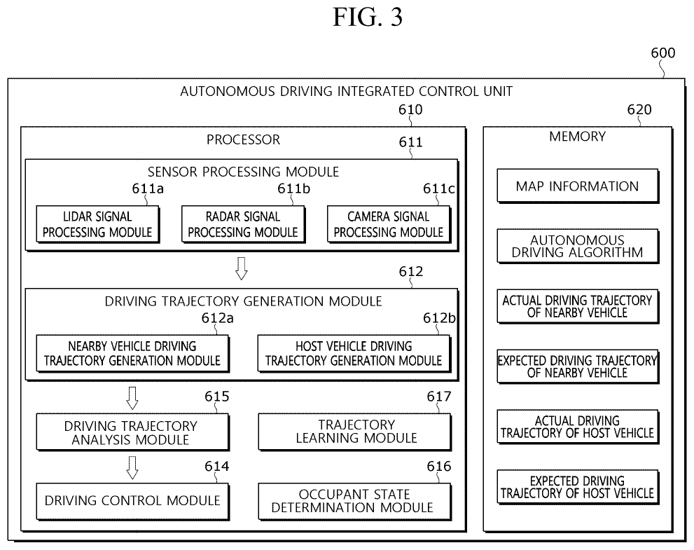

FIG. 3 shows an example of a detailed configuration of a processor and a memory for autonomous driving control in an autonomous driving device according to an example of the present disclosure.

Referring to FIG. 3, a memory 620 may store basic information necessary for autonomous driving control of a vehicle or information generated when autonomous driving of the vehicle is controlled by a processor 610, and the processor 610 may access (read) the information stored in the memory 620 to control the autonomous driving of the vehicle. The memory 620 may be implemented as a computer-readable recording medium and may operate so that the processor 610 may access the memory. Specifically, the memory 620 may be implemented as a hard drive, a magnetic tape, a memory card, a read only memory (ROM), a random access memory (RAM), or an optical data storage device such as a digital video disc (DVD) or an optical disc (e.g., Blu-ray, CD-ROM, or optical jukebox library, etc.).

The memory 620 may store map information required for autonomous driving control in the processor 610. The map information stored in the memory 620 may be a navigation map (digital topographic map) that provides information in road units, but may be preferably implemented as a precision road map that provides road information in lane units in order to improve the precision of autonomous driving control, that is, 3D high-precision electronic map data (e.g., HD lane-level maps, elevation/gradient layers, or semantic road furniture, etc.). Accordingly, the map information stored in the memory 620 may provide dynamic and static information necessary for the autonomous driving control of the vehicle, such as lanes, lane centerlines, regulatory lines, road boundaries, road centerlines, traffic signs, road surface signs, road shapes and heights, and lane widths (e.g., merge zones, gore areas, or shoulder widths, etc.).

Further, the memory 620 may store an autonomous driving algorithm for the autonomous driving control of the vehicle. The autonomous driving algorithm is an algorithm (recognition, determination, and control algorithm) for recognizing surroundings of the autonomous vehicle, determining a state thereof, and controlling the driving of the vehicle based on a result of the determination, and the processor 610 may execute the autonomous driving algorithm stored in the memory 620 to perform active autonomous driving control in the surrounding environment of the vehicle (e.g., perception fusion, trajectory planning, or model predictive control, etc.).

The processor 610 may control autonomous driving of the vehicle based on driving information and traveling information input from the interface provided through the display 108 described above, information on nearby objects detected through the sensor unit 104, the map information and the autonomous driving algorithm stored in the memory 620. The processor 610 may be implemented as an embedded processor such as a complex instruction set computer (CISC) or a reduced instruction set computer (RISC), or a dedicated semiconductor circuit such as an application specific integrated circuit (ASIC) (e.g., GPU, TPU, or FPGA accelerator, etc.).

In the present example, the processor 610 may analyze respective driving trajectories of the host vehicle and a nearby vehicle to control autonomous driving of the host vehicle, and to this end, the processor 610 may include a sensor processing module 611, a driving trajectory generation module 612, a driving trajectory analysis module 613, a driving control module 614, a trajectory learning module 615, and an occupant state determination module 616, as illustrated in FIG. 3. Although FIG. 3 illustrates respective modules as independent blocks according to their functions, the modules may be integrated into one module to perform respective functions in an integrated manner (e.g., consolidated into a centralized vehicle domain controller, etc.).

The sensor processing module 611 may determine driving information of the nearby vehicle (that is, which includes a position of the nearby vehicle and may further include a speed and moving direction of the nearby vehicle together with the position) based on a result of detecting a vehicle near the host vehicle through the sensor unit 104. That is, the sensor processing module 611 may determine the position of the nearby vehicle based on a signal received through a lidar sensor 104b, may determine the position of the nearby vehicle based on a signal received through the radar sensor 104c, or may determine the position of the nearby vehicle based on an image captured through the camera 104a (e.g., stereo depth, optical flow, or monocular depth estimation, etc.). A method of determining the position of the nearby vehicle by utilizing the lidar sensor 104b, the radar sensor 104c, and the camera 104a is a specific example, and an implementation scheme therefor is not limited (e.g., EKF, UKF, or particle filter, etc.). Further, the sensor processing module 611 may determine attribute information such as a size and type of the nearby vehicle as well as the position, speed, and moving direction of the nearby vehicle, and an algorithm for determining information such as the position, speed, moving direction, size, and type of the nearby vehicle as described above may be defined in advance (e.g., CNN-based classifier, 3D bounding box estimator, or multi-object tracker, etc.).

The driving trajectory generation module 612 may generate the actual driving trajectory and expected driving trajectory of the nearby vehicle and the actual driving trajectory of the host vehicle, and to this end, the driving trajectory generation module 612 may include a nearby vehicle driving trajectory generation module 612a and a host vehicle driving trajectory generation module 612b, as illustrated in FIG. 3.

First, the nearby vehicle driving trajectory generation module 612a may generate the actual driving trajectory of the nearby vehicle.

Specifically, the nearby vehicle driving trajectory generation module 612a may generate the actual driving trajectory of the nearby vehicle based on the driving information of the nearby vehicle detected by the sensor unit 104 (that is, the position of the nearby vehicle determined by the sensor processing module 611). In this case, in order to generate the actual driving trajectory of the nearby vehicle, the nearby vehicle driving trajectory generation module 612a may refer to the map information stored in the memory 620, and may generate the actual driving trajectory of the nearby vehicle by cross-referencing the position of the nearby vehicle detected by the sensor unit 104 and an arbitrary position in the map information stored in the memory 620 (e.g., lane centerline, waypoint grid, or HD node, etc.). For example, when the nearby vehicle is detected at a specific point by the sensor unit 104, the nearby vehicle driving trajectory generation module 612a may specify the position of the currently detected nearby vehicle in the map information by cross-referencing the position of the detected nearby vehicle and the arbitrary position in the map information stored in the memory 620, and may generate the actual driving trajectory of the nearby vehicle by continuously monitoring the position of the nearby vehicle as described above (e.g., at 10 Hz, 20 Hz, or 50 Hz, etc.). That is, the nearby vehicle driving trajectory generation module 612a may generate the actual driving trajectory of the nearby vehicle by mapping the position of the nearby vehicle detected by the sensor unit 104 to a position in the map information stored in the memory 620 based on the cross-reference and accumulating the position (e.g., polyline, spline, or clothoid segments, etc.).

Meanwhile, the actual driving trajectory of the nearby vehicle may be compared with the expected driving trajectory of the nearby vehicle to be described below and utilized to determine whether the map information stored in the memory 620 is inaccurate. In this case, when an actual driving trajectory of a specific nearby vehicle is compared with an expected driving trajectory, a problem that the map information is incorrectly determined to be inaccurate even though the map information is accurate may occur. For example, when an actual driving trajectory and an expected driving trajectory of a number of nearby vehicles match, but an actual driving trajectory and an expected driving trajectory of any specific nearby vehicle do not match, comparing only the actual driving trajectory of the specific nearby vehicle with the expected driving trajectory may lead to an incorrect determination that the map information is inaccurate even though the map information is accurate. Therefore, it is necessary to determine whether actual driving trajectories of a plurality of nearby vehicles tend to deviate from expected driving trajectories, and to this end, the nearby vehicle driving trajectory generation module 612a may generate respective actual driving trajectories of the plurality of nearby vehicles (e.g., aggregate over 5, 10, or 20 vehicles, etc.). Further, considering that a driver of the nearby vehicle tends to slightly move a steering wheel left and right during a driving process for driving on a straight path, the actual driving trajectory of the nearby vehicle may be generated in a curved form rather than a straight form, and in order to calculate an error between the actual driving trajectory and an expected driving trajectory to be described later, the nearby vehicle driving trajectory generation module 612a may apply a predetermined smoothing scheme to a raw actual driving trajectory generated in a curved form to generate the actual driving trajectory in a straight shape (e.g., moving average, or spline smoothing, etc.). Any scheme such as interpolation for each position of the nearby vehicle may be employed as the smoothing scheme (e.g., linear, cubic, or Kalman-smoothed interpolation, etc.).

Further, the nearby vehicle driving trajectory generation module 612a may generate the expected driving trajectory of the nearby vehicle based on the map information stored in the memory 620.

As described above, the map information stored in the memory 620 may be three-dimensional high-precision electronic map data, and thus the map information may provide dynamic and static information necessary for autonomous driving control of the vehicle, such as lanes, lane centerlines, regulatory lines, road boundaries, road centerlines, traffic signs, road surface signs, road shapes and heights, and lane widths. Considering that a vehicle generally drives at a center of a lane, it may be expected that a nearby vehicle near the host vehicle will also travel at the center of the lane, and therefore, the nearby vehicle driving trajectory generation module 612a may generate the expected driving trajectory of the nearby vehicle as a lane centerline reflected in the map information (e.g., center spline, waypoint chain, or reference line, etc.).

The host vehicle driving trajectory generation module 612b may generate the actual driving trajectory along which the host vehicle has driven so far, based on the driving information of the host vehicle acquired through the interface provided through the display 108 (e.g., GPS receiver 260, odometry, or IMU fusion, etc.).

Specifically, the host vehicle driving trajectory generation module 612b may generate the actual driving trajectory of the host vehicle by cross-referencing the position of the host vehicle acquired through the interface provided through the display 108 (that is, the position information of the host vehicle acquired through a GPS receiver 260) and an arbitrary position in the map information stored in the memory 620. For example, the current position of the host vehicle may be specified in the map information by cross-referencing the position of the host vehicle acquired through the interface provided through the display 108 and the arbitrary position in the map information stored in the memory 620, and the actual driving trajectory of the host vehicle may be generated by continuously monitoring the position of the host vehicle as described above. That is, the host vehicle driving trajectory generation module 612b may generate the actual driving trajectory of the host vehicle by mapping the position of the host vehicle acquired through the interface provided through the display 108 to the position in the map information stored in the memory 620 based on the cross-reference and accumulating the position (e.g., constructing a breadcrumb trail or time-stamped path, etc.).

Further, the host vehicle driving trajectory generation module 612b may generate the expected driving trajectory along which the host vehicle should drive to the destination based on the map information stored in the memory 620.

That is, the host vehicle driving trajectory generation module 612b may generate the expected driving trajectory to the destination by using the current position of the host vehicle acquired through the interface (that is, current position information of the host vehicle acquired through the GPS receiver 260) and the map information stored in the memory, and the expected driving trajectory of the host vehicle may be generated as a lane center line reflected in the map information stored in the memory 620, like the expected driving trajectories of the nearby vehicle (e.g., fastest route, eco route, or toll-avoid route, etc.).

The driving trajectories generated by the nearby vehicle driving trajectory generation module 612a and the host vehicle driving trajectory generation module 612b may be stored in the memory 620 and may be utilized for various purposes when the processor 610 controls autonomous driving of the host vehicle (e.g., collision prediction, path replanning, or HD map validation, etc.).

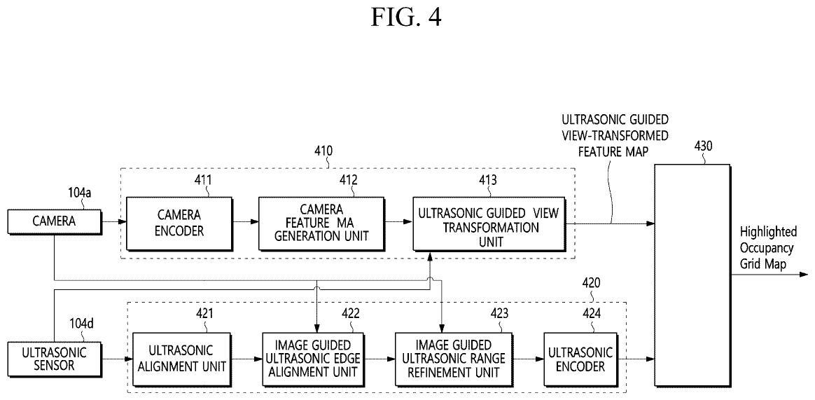

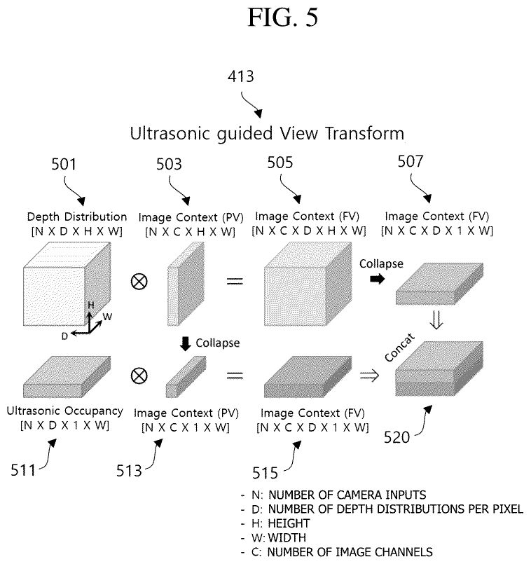

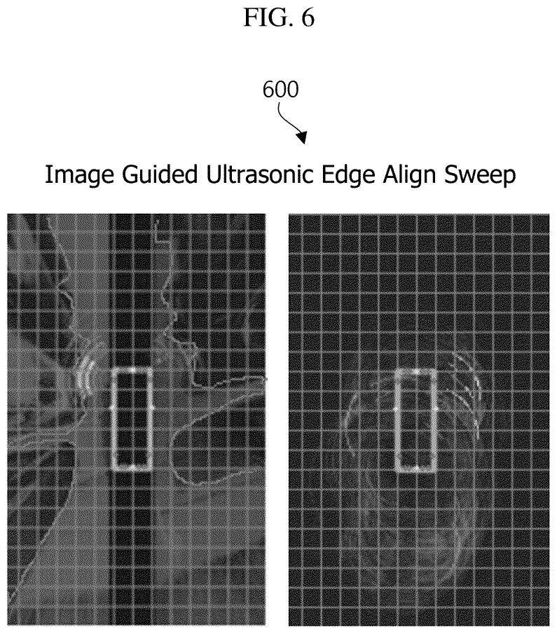

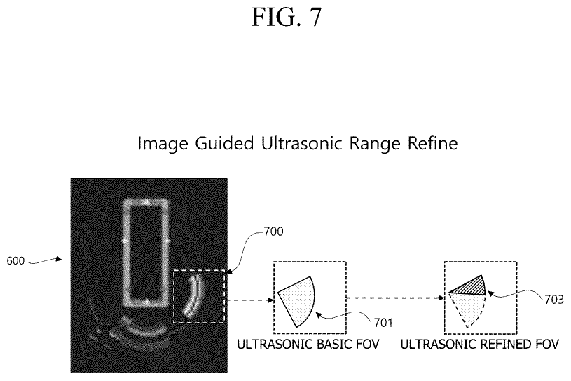

Further, an example of the present disclosure is characterized in that the nearby vehicle driving trajectory generation module 612a tracks a state trajectory of a target object near the host vehicle estimated from a position measurement value obtained by detecting the target object, and a detailed operation of tracking the state trajectory of the target object according to the example of the present disclosure will be described in detail with reference to FIG. 4, FIG. 5, FIG. 6, and FIG. 7 below (e.g., constant-velocity, constant-acceleration, or CTRV motion models, etc.).

The driving trajectory analysis module 613 may diagnose current reliability of the autonomous driving control for the host vehicle by analyzing respective driving trajectories (that is, the actual driving trajectory and expected driving trajectory of the nearby vehicle, and the actual driving trajectory of the host vehicle) generated by the driving trajectory generation module 612 and stored in the memory 620. The diagnosis of the reliability of the autonomous driving control may be performed by analyzing a trajectory error between the actual driving trajectory and the expected driving trajectory of the nearby vehicle (e.g., lateral offset, heading deviation, or curvature mismatch, etc.).

The driving control module 614 may perform a function of controlling autonomous driving of the host vehicle, and specifically, the driving control module 614 may comprehensively use driving information and traveling information input from the interface provided through the display 108 described above, information on nearby objects detected through the sensor unit 104 (e.g., camera, radar, or LiDAR, etc.), and the map information stored in the memory 620 to process the autonomous driving algorithm, and transfer control information through the interface provided through the display 108 to cause a low-level control system to control autonomous driving of the host vehicle (e.g., throttle/brake commands or steering angles, etc.). Further, when the driving control module 614 controls the autonomous driving as described above in an integrated manner, the driving control module 614 controls the autonomous driving in consideration of the driving trajectories of the host vehicle and the nearby vehicle analyzed by the sensor processing module 611, the driving trajectory generation module 612, and the driving trajectory analysis module 613 described above, thereby improving the precision and stability of the autonomous driving control (e.g., smoother lane keeping, reduced overshoot, or safer gap selection, etc.).

The trajectory learning module 615 may perform learning or correction on the actual driving trajectory of the host vehicle generated by the host vehicle driving trajectory generation module 612b. For example, when the trajectory error between the actual driving trajectory and the expected driving trajectory of the nearby vehicle is equal to or greater than a preset threshold value, it may be determined that the map information stored in the memory 620 is inaccurate and the actual driving trajectory of the host vehicle needs to be refined, and accordingly, a lateral shift value for correcting the actual driving trajectory of the host vehicle may be determined so that the driving trajectory of the host vehicle may be refined (e.g., shift to lane centerline by 0.2-0.5 m, re-fit a spline, or re-sample waypoints, etc.).

The occupant state determination module 616 may determine a state and behavior of an occupant based on a state and bio signal of an occupant detected by an internal camera sensor 535 and a biosensor (e.g., heart rate, eye blink rate, or head pose, etc.). The occupant state determined by the occupant state determination module 616 may be utilized when the autonomous driving of the host vehicle is performed or a warning is output to the occupant (e.g., takeover request, drowsiness alert, or seatbelt reminder, etc.).

Hereinafter, a sensor fusion operation of an image signal processing module and an ultrasonic signal processing module according to an example of the present disclosure will be described in detail.

FIG. 4 shows an example of a configuration unit for processing sensor fusion of the image signal processing module and the ultrasonic signal processing module according to the example of the present disclosure.

Referring to FIG. 4, a camera/ultrasonic sensor fusion unit 400 may include an image signal processing module 410, an ultrasonic signal processing module 420, and a sensor fusion unit 430. Here, the image signal processing module 410 and the ultrasonic signal processing module 420 may be models corresponding to the image signal processing module 611c and the ultrasonic signal processing module 611d illustrated in FIG. 3, respectively.

First, the image signal processing module 410 may include a camera encoder 411, a camera feature map construction unit 412, and an ultrasonic-guided view transformation unit 413.

The camera encoder 411 may perform encoding on an image signal input from a camera 104a, and the camera feature map construction unit 412 may construct a feature map using the encoded image signal. The camera feature map construction unit 412 may include a camera feature map generation model, the encoded image signal may be input to the camera feature map generation model, and a camera feature map may be constructed using an output from the camera feature map generation model. Here, the camera feature map generation model may be a learning model constructed based on a CNN network, and may be a model trained to receive the encoded image signal and construct the camera feature map using an output thereof (e.g., ResNet, U-Net, or FPN backbone, etc.).

The ultrasonic-guided view transformation unit 413 may generate a bird's-eye-view (BEV) feature map by reflecting short-range depth information obtained by accumulating ultrasonic signals detected by the ultrasonic sensor 104d in ImageNet-based depth distribution information, unlike a scheme in which the view transformation used in other BEV fusion utilizes only the ImageNet-based depth distribution information (e.g., without ultrasonic depth correction, etc.).

For example, referring to FIG. 5, the ultrasonic-guided view transformation unit 413 may generate image context information (FV) 505 having a size of N×C×H×W by reflecting image context information (PV) 503 having a size of N×C×H×W in depth distribution information 501 having a size of N×D×H×W. Further, the ultrasonic-guided view transformation unit 413 may collapse the image context information (FV) 505 having the size of N×C×D×H×W to construct image context information (FV) 507 having a size of N×C×D×1×W.

Further, the ultrasonic-guided view transformation unit 413 may check ultrasonic occupancy information 511 having a size of N×D×1×W using the ultrasonic signal provided from the ultrasonic sensor 104d, and may generate the image context information (FV) 515 having the size of N×C×D×1×W by reflecting image context information (PV) 513 having a size of N×C×1×W in the ultrasonic occupancy information 511 having a size of N×D×1×W. Here, the image context information (PV) 513 having the size of N×C×1×W may be information constructed by collapsing the image context information (PV) 503 having the size of N×C×H×W (e.g., height pooling, vertical aggregation, or projection, etc.).

The ultrasonic-guided view transformation unit 413 may concatenate ultrasonic-guided image context information (FV) 515 having the size of N×C×D×1×W to the image context information (FV) 507 having the size of N×C×D×1×W constructed through the above-described operation to fuse the image feature information (e.g., sum, or average, etc.). Accordingly, the ultrasonic-guided view transformation unit 413 may construct an ultrasonic-guided view-transformed BEV feature map 520 that reflects both the depth information of the image feature information and the depth information based on ultrasonic data through the depth distribution information 501 having the size of N×D×H×W and the ultrasonic occupancy information 511 having the size of N×D×1×W.

Referring to FIG. 4, the ultrasonic signal processing module 420 may include an ultrasonic alignment unit 421, an image-guided ultrasonic edge alignment unit 422, an image-guided ultrasonic range refinement unit 423, and an ultrasonic encoder 424.

The ultrasonic alignment unit 421 may generate an ultrasonic BEV image using the raw signal provided from each ultrasonic sensor 104d (e.g., time-of-flight return, amplitude, or confidence value, etc.).

The image-guided ultrasonic edge alignment unit 422 may generate an image obtained by summing the BEV images by compensating and accumulating information on the ultrasonic BEV image for a desired time t, t−1, . . . , t−n with reference to a current time. In this case, the summation of the BEV images may be performed using a simple addition, concatenation, or averaging scheme (e.g., running mean, weighted sum, or temporal concatenation, etc.). The image-guided ultrasonic edge alignment unit 422 may check a camera BEV feature map provided from the image signal processing module 410, and may perform alignment of an ultrasonic BEV feature map swept with reference to the current time based on an object included in the camera BEV feature map (e.g., align to visual object boundaries, corners, or edges, etc.).

For example, the image-guided ultrasonic edge alignment unit 422 may construct and output an image-guided ultrasonic edge-aligned feature map 600 (see FIG. 6) through the above-described operation.

Referring back to FIG. 4, the image-guided ultrasonic range refinement unit 423 may perform refinement of an ultrasonic detection value in an area for the object included in the image-guided ultrasonic edge-aligned feature map 600 (e.g., clip outliers, adjust range bins, or update occupancy likelihoods, etc.). For example, referring to FIG. 7, the image-guided ultrasonic range refinement unit 423 may detect an ultrasonic refined FOV 703 by performing refinement of an ultrasonic detection value of an ultrasonic basic FOV 701 detected based on ultrasonic information for an area 700 (see FIG. 7) where the object exists in the image-guided ultrasonic edge-aligned feature map 600. Accordingly, the image-guided ultrasonic range refinement unit 423 may construct an image-guided ultrasonic BEV feature map including the ultrasonic refined FOV 703.

Meanwhile, the ultrasonic encoder 424 may encode the image-guided ultrasonic BEV feature map generated by the image-guided ultrasonic range refinement unit 423. For example, the ultrasonic encoder 424 may be a learning model constructed based on a CNN network, and may be a model trained to receive the image-guided ultrasonic BEV feature map and construct an encoding value for the ultrasonic BEV feature information using an output thereof (e.g., feature pyramid encoder, bottleneck embedding, or attention-based encoder, etc.). Referring back to FIG. 4, the sensor fusion unit 430 may fuse the ultrasonic-guided view-transformed BEV feature map generated by the image signal processing module 410 with the image-guided ultrasonic BEV feature map generated by the ultrasonic signal processing module 420 to construct a weighted occupancy map (Highlighted Occupancy Grid Map), and output the weighted occupancy map as a BEV fusion feature map (e.g., via concatenation, summation, or averaging, etc.) . . . . The fusion of the ultrasonic-guided view-transformed BEV feature map with the image-guided ultrasonic BEV feature map may be performed using, for example, a concatenation, summation, and averaging scheme.

Further, the sensor fusion unit 430 may further include a CNN-based fusion feature map generation model, and may input the weighted occupancy map generated by fusing the ultrasonic-guided view-transformed BEV feature map with the image-guided ultrasonic BEV feature map to the fusion feature map generation model, and output a BEV fusion feature map obtained by reconstructing the feature map using the CNN network.

Further, the sensor fusion unit 430 may generate BEV segmentation information using the BEV fusion feature map or generate obstacle edge detection information using the BEV fusion feature map. The sensor fusion unit 430 may include a BEV segmentation model that generates the BEV segmentation information and an obstacle edge detection model, and may input the BEV fusion feature map to the BEV segmentation model and the obstacle edge detection model to generate the BEV segmentation information and the obstacle edge detection information (e.g., drivable area mask, object instance boundaries, or curb lines, etc.).

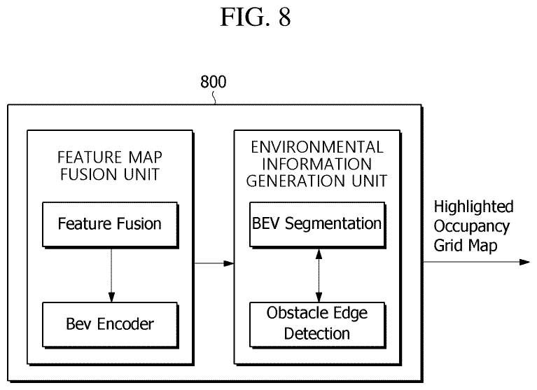

Further, the BEV segmentation model and the obstacle edge detection model may exchange information with each other to perform learning. For example, as illustrated in FIG. 8, the sensor fusion unit 800 may perform simultaneous learning of the BEV segmentation model and the obstacle edge detection model, and enhance performance by causing information to be exchanged between the models during learning (e.g., shared features, cross-loss terms, or Knowledge Distillation, etc.).

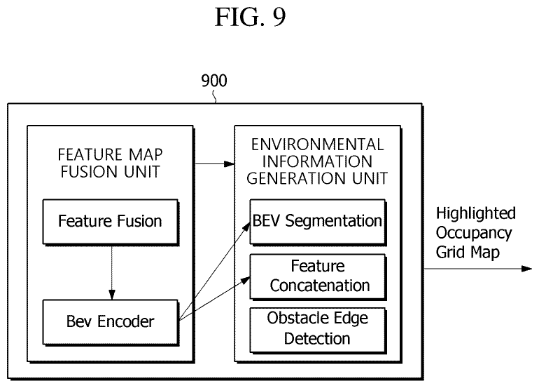

As another example, as illustrated in FIG. 9, the sensor fusion unit 900 may further include a feature concatenation model that further concatenates BEV feature information output from a BEV encoder with an output value (e.g., class information, class probabilities, logits, or feature vectors, etc.) of the BEV segmentation model, and may input an output value of the feature concatenation model to the obstacle edge detection model to generate obstacle edge detection information. Thus, the sensor fusion unit 900 may further include the feature concatenation model, thereby outputting a more precise obstacle edge detection result (e.g., sharper curb/median edges, clearer object outlines, or reduced false positives, etc.).

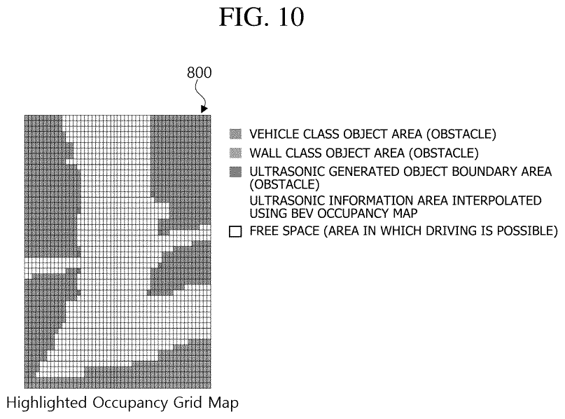

As described above, the BEV occupancy map may be generated using the BEV segmentation information through the BEV segmentation model, but an occupancy map generated based on an image has the characteristic that boundary information is inaccurate due to characteristics of the image. Considering this, the obstacle edge detection information may be reflected in the BEV segmentation information so that an occupancy map 1000 (see FIG. 10) in which the obstacle edge detection information is highlighted may be constructed. Specifically, the boundary information may be constructed more clearly using ultrasonic information matching the BEV occupancy map, and depth information of an ultrasonic signal may indicate that a corresponding position is information that requires caution at the time of driving (e.g., close-range obstacles, protrusions, or narrow gaps, etc.). Further, because the ultrasonic signal has a long detection cycle due to characteristics of the sensor, information may be constructed sparsely. Considering this, ultrasonic interpolation may be performed by utilizing outline information of the object that may be obtained from the generated BEV occupancy map (e.g., filling sparse cells along object contours, densifying near edges, or smoothing discontinuities, etc.).

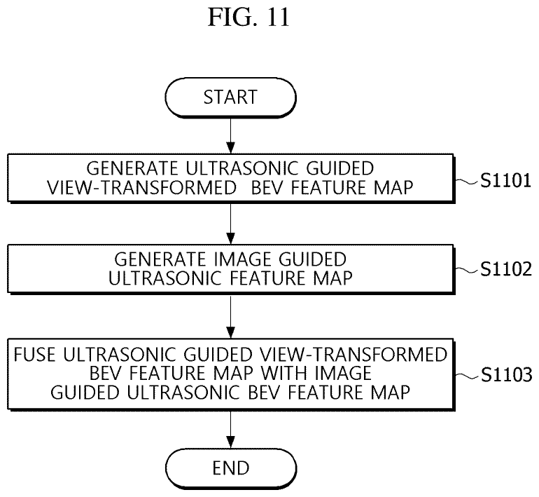

FIG. 11 shows an example of an operation of a method of fusing camera and ultrasonic sensor information according to an example of the present disclosure.

The method of fusing camera and ultrasonic sensor information according to the example of the present disclosure may be performed by the processor of the vehicle described above.

Referring to FIG. 11, the processor 610 may generate the ultrasonic-guided view-transformed BEV feature map (S1101).

Specifically, the processor 610 may perform encoding on the image signal input from the camera 104a and construct the feature map using the encoded image signal. In this case, the processor 610 may generate the ultrasonic-guided view-transformed BEV feature map using the camera feature map generation model, input the encoded image signal to the camera feature map generation model, and construct the camera feature map using the output thereof. Here, the camera feature map generation model may be a learning model constructed based on the CNN network, and may be a model trained to receive the encoded image signal and construct the camera feature map using an output thereof (e.g., backbone extractor, feature pyramid, or encoder-decoder, etc.).

The processor 610 may generate the BEV feature map by reflecting the short-range depth information obtained by accumulating ultrasonic signals detected by the ultrasonic sensor 104d in ImageNet-based depth distribution information, unlike a scheme in which the view transformation used in other BEV fusion utilizes only the ImageNet-based depth distribution information (e.g., without incorporating ultrasonic occupancy cues, etc.).

For example, referring to FIG. 5, the processor 610 may generate the image context information (FV) 505 having a size of N×C×H×W by reflecting image context information (PV) 503 having a size of N×C×H×W in depth distribution information 501 having a size of N×D×H×W. Further, the processor 610 may collapse the image context information (FV) 505 having the size of N×C×D×H×W to construct the image context information (FV) 507 having a size of N×C×D×1×W (e.g., height pooling, vertical squeeze, or axis reduction, etc.).

Further, the processor 610 may check ultrasonic occupancy information 511 having a size of N×D×1×W using the ultrasonic signal provided from the ultrasonic sensor 104d, and may generate the image context information (FV) 515 having the size of N×C×D×1×W by reflecting image context information (PV) 513 having a size of N×C×1×W to the ultrasonic occupancy information 511 having a size of N×D×1×W. Here, the image context information (PV) 513 having the size of N×C×1×W may be information constructed by collapsing the image context information (PV) 503 having the size of N×C×H×W.

The processor 610 may concatenate the image context information (FV) 515 having the size of N×C×D×1×W with the image context information (FV) 507 having the size of N×C×D×1×W constructed through the above-described operation to construct the ultrasonic-guided view-transformed BEV feature map 520 (e.g., channel-wise concatenation, summation, or averaging, etc.).

Further, the processor 610 may generate an image guided ultrasonic feature map (S1102).

Specifically, the processor 610 may generate an ultrasonic BEV image using the raw signal provided from each ultrasonic sensor 104d (e.g., time-of-flight, amplitude, or confidence, etc.).

The processor 610 may generate the image obtained by summing the BEV images by compensating and accumulating information on the ultrasonic BEV image for the desired time t, t−1, . . . , t−n with reference to the current time. In this case, the summation of the BEV images may be performed using a simple addition, concatenation, or averaging scheme (e.g., weighted sum, running mean, or temporal stacking, etc.). The image-guided ultrasonic edge alignment unit 422 may check the camera BEV feature map, and may perform alignment of the ultrasonic BEV feature map swept with reference to the current time based on the object included in the camera BEV feature map (e.g., align to visual edges, corners, or silhouettes, etc.).

For example, the processor 610 may construct and output the image-guided ultrasonic edge-aligned feature map 600 through the above-described operation.

The processor 610 may perform refinement of the ultrasonic detection value in the area for the object included in the image-guided ultrasonic edge-aligned feature map 600. For example, referring to FIG. 7, the processor 610 may detect an ultrasonic refined FOV 703 by performing refinement of the ultrasonic detection value of the ultrasonic basic FOV 701 detected based on the ultrasonic information for the area 700 where the object exists in the image-guided ultrasonic edge-aligned feature map 600 (e.g., remove spurious ranges, clamp extremes, or adjust confidence thresholds, etc.). Accordingly, the processor 610 may construct an image-guided ultrasonic BEV feature map including the ultrasonic refined FOV 703.

Further, the processor 610 may encode the generated image-guided ultrasonic BEV feature map. For example, an encoder (e.g., the processor 610) may be a learning model constructed based on a CNN network, and may be a model trained to receive the image-guided ultrasonic BEV feature map and construct an encoding value for the ultrasonic BEV feature information using an output thereof (e.g., feature bottleneck, attention block, or pyramid encoder, etc.).

Next, the processor 610 may fuse the ultrasonic-guided view-transformed BEV feature map with the image-guided ultrasonic BEV feature map to construct a weighted occupancy map (Highlighted Occupancy Grid Map), and output the weighted occupancy map as the BEV fusion feature map (S1103) (e.g., concatenate, sum, or average, etc.). The fusion of the ultrasonic-guided view-transformed BEV feature map with the image-guided ultrasonic BEV feature map may be performed using, for example, a concatenation, summation, and averaging scheme.

Further, the processor 610 may apply a CNN-based fusion feature map generation model, and may input the weighted occupancy map generated by fusing the ultrasonic-guided view-transformed BEV feature map with the image-guided ultrasonic BEV feature map to the fusion feature map generation model, and output a BEV fusion feature map obtained by reconstructing the feature map using the CNN network.

Further, the processor 610 may generate the BEV segmentation information using the BEV fusion feature map or generate the obstacle edge detection information using the BEV fusion feature map. The processor 610 may include the BEV segmentation model that generates the BEV segmentation information and the obstacle edge detection model, and may input the BEV fusion feature map to the BEV segmentation model and the obstacle edge detection model to generate the BEV segmentation information and the obstacle edge detection information (e.g., drivable area mask, instance boundaries, or curb lines, etc.).

Further, the BEV segmentation model and the obstacle edge detection model may exchange information with each other to perform learning. For example, as illustrated in FIG. 8, the processor 610 may perform simultaneous learning of the BEV segmentation model and the obstacle edge detection model, and enhance performance by causing information to be exchanged between the models during learning (e.g., shared feature backbone, cross-loss terms, or teacher-student distillation, etc.).

As another example, as illustrated in FIG. 9, the processor 610 may further include a feature concatenation model that further concatenates the BEV feature information output from the BEV encoder to an output value (e.g., class information, class probabilities, logits, or feature vectors, etc.) of the BEV segmentation model, and may input an output value of the feature concatenation model to the obstacle edge detection model to generate the obstacle edge detection information. Thus, the processor 610 may further include the feature concatenation model, thereby enabling a more precise obstacle edge detection result (e.g., clearer boundaries, reduced leakage, or improved edge confidence, etc.).

As described above, the BEV occupancy map may be generated using the BEV segmentation information through the BEV segmentation model, but an occupancy map generated based on an image has the characteristic that boundary information is inaccurate due to characteristics of the image. Considering this, the obstacle edge detection information may be reflected in the BEV segmentation information so that an occupancy map 1000 (see FIG. 10) in which the obstacle edge detection information is highlighted may be constructed. Specifically, the boundary information may be constructed more clearly using ultrasonic information matching the BEV occupancy map, and depth information of an ultrasonic signal may indicate that a corresponding position is information that requires caution at the time of driving (e.g., protruding obstacles, tight gaps, or close-range hazards, etc.). Further, because the ultrasonic signal has a long detection cycle due to characteristics of the sensor, information may be constructed sparsely. Considering this, ultrasonic interpolation may be performed by utilizing outline information of the object that may be obtained from the generated BEV occupancy map (e.g., contour-guided filling, edge-aware densification, or local smoothing near outlines, etc.).

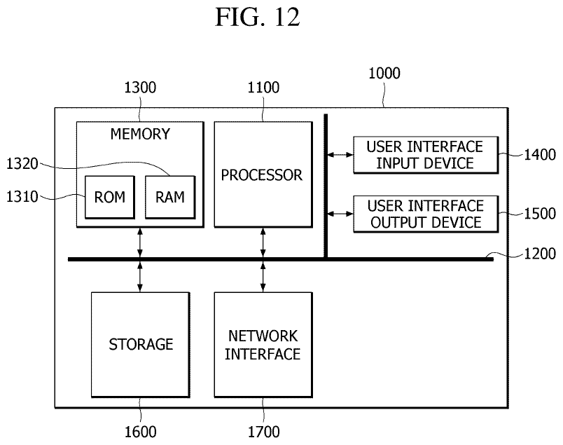

FIG. 12 shows an example computing system (e.g., a computing device of a vehicle or any other apparatus). One or more controllers, processors, etc. described herein, such as one or more components of the vehicle 100, one or more components of the server 200, one or more components of another vehicle 400, and any other components and devices disclosed herein, may be implemented by or in the computing system as shown in FIG. 12.

A computing system 1000 may include at least one processor 1100, memory 1300, a user interface input device 1400, a user interface output device 1500, a storage 1600, and a network interface 1700, which relate to each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example example(s) disclosed in the specification may be implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

In accordance with an example of the present disclosure, there is provided a method for fusing camera and ultrasonic sensor data, comprising: determining ultrasonic data detected by an ultrasonic sensor and generating ultrasonic feature information based on the ultrasonic data; determining image data input through a camera and generating image feature information based on the image data; performing view transformation by reflecting depth information of the image feature information and depth information based on the ultrasonic data and generating ultrasonic guided view-transformed bird's-eye-view (BEV) feature information using the view-transformed data; aligning the ultrasonic feature information based on information on an object included in the image feature information and generating ultrasonic BEV feature information using the aligned ultrasonic feature information; and fusing the ultrasonic guided view-transformed BEV feature information and the ultrasonic BEV feature information.

The generating of the ultrasonic guided view-transformed BEV feature information may include estimating a depth distribution based on the image feature information; performing image view transformation based on the estimated depth distribution, generating a first BEV feature information using image view-transformed data based on the estimated depth distribution; determining the depth information based on the ultrasonic data; performing image view transformation based on the depth information based on the ultrasonic data; generating a second BEV feature information using data view-transformed based on the depth information based on the ultrasonic data; and generating the ultrasonic guided view-transformed BEV feature information by concatenating the first BEV feature information and the second BEV feature information to perform fusion.

The generating of the ultrasonic feature information may include determining a plurality of pieces of ultrasonic data detected through an ultrasonic sensor at different times; performing compensation on each of the plurality of pieces of ultrasonic data with reference to one of the different times; and accumulating the plurality of compensated pieces of ultrasonic data to generate the ultrasonic feature information.

The generating of the ultrasonic feature information may include accumulating the plurality of compensated pieces of ultrasonic data based on information on an object included in the image feature information.

The generating of the ultrasonic BEV feature information may include correcting an area of the object included in the aligned ultrasonic feature information according to an area of the object included in the image feature information.

The method may further comprise determining BEV feature information generated when encoding the ultrasonic guided view-transformed BEV feature information, to generate

BEV object information obtained by distinguishing a BEV object using the BEV feature information; and generating obstacle boundary information obtained by detecting an obstacle boundary using the BEV feature information.

The distinguishing of the BEV object may include distinguishing the BEV object using the obstacle boundary information, and the detecting of the obstacle boundary includes detecting the obstacle boundary using the BEV object information.

The method may further comprise determining BEV feature information generated when encoding the ultrasonic guided view-transformed BEV feature information, to generate BEV object information obtained by distinguishing a BEV object using the BEV feature information; fusing the feature information by concatenating the BEV object information to BEV feature information generated when encoding the ultrasonic guided view-transformed BEV feature information; and generating obstacle boundary information obtained by detecting an obstacle boundary using the BEV feature information in which the BEV object information is fused.

In accordance with another example of the present disclosure, there is provided a vehicle, the vehicle comprises a sensor unit configured to detect a target object present near a host vehicle during autonomous driving, wherein the sensor unit includes a camera and an ultrasonic sensor; a memory configured to store a sensor fusion program; and a processor configured to load the sensor fusion program from the memory, wherein the processor is configured to execute the sensor fusion program to: determine ultrasonic data detected by the ultrasonic sensor and generate an ultrasonic feature information based on the ultrasonic data; determine image data input through the camera and generate an image feature information based on the image data; perform view transformation by reflecting depth information of the image feature information and depth information based on the ultrasonic data and generate an ultrasonic guided view-transformed bird's-eye-view (BEV) feature information using the view-transformed data; align the ultrasonic feature information based on information on an object included in the image feature information and generate an ultrasonic BEV feature information using the aligned ultrasonic feature information; and fuse the ultrasonic guided view-transformed BEV feature information and the ultrasonic BEV feature information.

The processor may be configured to: estimate a depth distribution based on the image feature information; perform image view transformation based on the estimated depth distribution, generate a first BEV feature information using image view-transformed data based on the estimated depth distribution; determine the depth information based on the ultrasonic data; perform image view transformation based on the depth information based on the ultrasonic data; generate a second BEV feature information using data image view-transformed based on the depth information based on the ultrasonic data; and generate the ultrasonic guided view-transformed BEV feature information by concatenating the first BEV feature information and the second BEV feature information to perform fusion.

The processor may be configured to: determine a plurality of pieces of ultrasonic data detected through an ultrasonic sensor at different times; perform compensation on each of the plurality of pieces of ultrasonic data with reference to one of the different times; and accumulate the plurality of compensated pieces of ultrasonic data to generate the ultrasonic feature information.

The processor may be configured to: determine the plurality of compensated pieces of ultrasonic data based on information on an object included in the image feature information, and correct an area of the object included in the aligned ultrasonic feature information according to an area of the object included in the image feature information.

The processor may be configured to: determine BEV feature information generated when encoding the ultrasonic guided view-transformed BEV feature information, to generate BEV object information obtained by distinguishing a BEV object using the BEV feature information; and generate an obstacle boundary information obtained by distinguish the BEV object using the obstacle boundary information, and detecting an obstacle boundary using the BEV feature information.

The processor may be configured to: determine BEV feature information generated when encoding the ultrasonic guided view-transformed BEV feature information, to generate

BEV object information obtained by distinguishing a BEV object using the BEV feature information; fuse the feature information by concatenating the BEV object information to BEV feature information generated when encoding the ultrasonic guided view-transformed BEV feature information; and generate an obstacle boundary information obtained by detecting an obstacle boundary using the BEV feature information in which the BEV object information is fused.

In accordance with another example of the present disclosure, there is provided a non-transitory computer-readable storage medium including computer executable instructions, wherein the instructions, when executed by a processor, cause the processor to perform method for fusing camera and ultrasonic sensor data, the method comprise: determining ultrasonic data detected by an ultrasonic sensor and generating ultrasonic feature information based on the ultrasonic data; determining image data input through a camera and generating image feature information based on the image data; performing view transformation by reflecting depth information of the image feature information and depth information based on the ultrasonic data and generating ultrasonic guided view-transformed bird's-eye-view (BEV) feature information using the view-transformed data; aligning the ultrasonic feature information based on information on an object included in the image feature information and generating ultrasonic BEV feature information using the aligned ultrasonic feature information; and fusing the ultrasonic guided view-transformed BEV feature information and the ultrasonic BEV feature information.

According to the disclosed disclosure, it is possible to improve the reliability of camera BEV feature information by fusing data from an ultrasonic sensor with feature information of an image acquired from a camera.

Further, according to the disclosed disclosure, it is possible to improve the accuracy of feature information based on an ultrasonic sensor by fusing data from an ultrasonic sensor with feature information of an image acquired from a camera, and improve reliability of an object detected from the feature information of the image.

Further, according to the disclosed disclosure, it is possible to solve a problem of a position error that occurs when data from an ultrasonic sensor is accumulated and refine an ambiguous recognition range of the sensor.

Further, according to the disclosed disclosure, it is possible to generate an occupancy map with high object detection performance by utilizing mutual information through early fusion, compared to a late-fusion logic based on individual sensor processing.

According to the disclosed disclosure, it is possible to improve the reliability of the camera BEV feature information by fusing data from an ultrasonic sensor with feature information of an image acquired from a camera.

Further, according to the disclosed disclosure, it is possible to improve the accuracy of the feature information based on an ultrasonic sensor by fusing data from an ultrasonic sensor with feature information of an image acquired from a camera, and to improve the reliability of an object detected from the feature information of the image.

Further, according to the disclosed disclosure, it is possible to solve a problem of a position error that occurs when data from an ultrasonic sensor is accumulated and to refine an ambiguous recognition range of the sensor.

Further, according to the disclosed disclosure, it is possible to generate an occupancy map with high object detection performance by utilizing mutual information through early fusion, compared to a late-fusion logic based on individual sensor processing.

Combinations of steps in each flowchart attached to the present disclosure may be executed by computer program instructions. Since the computer program instructions may be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions may also be stored on a computer-usable or computer readable storage medium that may be accessed by a computer or other programmable data processing equipment to implement a function in a specific manner. Accordingly, the instructions stored on the computer-usable or computer-readable recording medium may also produce an article of manufacture containing instruction means for performing the functions described in each step of the flowchart. The computer program instructions may also be mounted on a computer or other programmable data processing equipment. Accordingly, a series of operational steps are performed on a computer or other programmable data processing equipment to create a computer-executable process, and it is also possible for instructions executed by a computer or other programmable data processing equipment to provide steps for performing the functions described in each step of the flowchart.

In addition, each step may represent a module, a segment, or a portion of code which contains one or more executable instructions for executing the specified logical function(s).

It should also be noted that in some alternative examples, the functions mentioned in the steps may occur out of order. For example, two steps illustrated in succession may in fact be performed simultaneously, or the steps may sometimes be performed in reverse order depending on the corresponding function.

The above description is merely an exemplary description of the technical scope of the present disclosure, and it will be understood by those skilled in the art that various changes and modifications may be made without departing from the original characteristics of the present disclosure. Therefore, the examples disclosed in the present disclosure are intended to explain, not to limit, the technical scope of the present disclosure, and the technical scope of the present disclosure is not limited by the examples. The protection scope of the present disclosure should be interpreted based on the following claims and it should be appreciated that all technical scopes included within ranges equivalent thereto are included in the protection scope of the present disclosure.

What is claimed is:

1. A method performed by a vehicle, the method comprising:
obtaining, via an ultrasonic sensor of the vehicle, ultrasonic data;
generating, based on the ultrasonic data, ultrasonic feature information;
obtaining, via a camera of the vehicle, image data;
generating, based on the image data, image feature information;
performing, based on first depth information associated with the image feature information and second depth information associated with the ultrasonic data, a view transformation on the image feature information;
generating, using the view-transformed image feature information, ultrasonic guided view-transformed bird's-eye-view (BEV) feature information;
adjusting, based on the image feature information, the ultrasonic feature information, wherein the image feature information comprises information on an object;
generating, using the adjusted ultrasonic feature information, ultrasonic BEV feature information;
fusing the ultrasonic guided view-transformed BEV feature information with the ultrasonic BEV feature information to generate fused BEV feature information;
outputting, based on the fused BEV feature information, a signal indicating the object; and
controlling, based on the signal, an operation of the vehicle.

2. The method of claim 1, wherein the generating of the ultrasonic guided view-transformed BEV feature information comprises:
estimating, based on the image feature information, a depth distribution;
performing, based on the estimated depth distribution, a view transformation on the image feature information to generate first BEV feature information,
determining, based on the ultrasonic data, the second depth information;
performing, based on the second depth information, a view transformation on the ultrasonic feature information to generate second BEV feature information; and
generating the ultrasonic guided view-transformed BEV feature information by fusing the first BEV feature information with the second BEV feature information.

3. The method of claim 1, wherein the generating of the ultrasonic feature information comprises:
determining a plurality of pieces of ultrasonic data detected via the ultrasonic sensor at different times;
performing compensation on each of the plurality of pieces of ultrasonic data with reference to one of the different times; and
accumulating the plurality of compensated pieces of ultrasonic data to generate the ultrasonic feature information.

4. The method of claim 3, wherein the accumulating of the plurality of compensated pieces of ultrasonic data is based on the image feature information including the object, and
wherein the generating of the ultrasonic BEV feature information comprises adjusting an area corresponding to the object that is included in the adjusted ultrasonic feature information.

5. The method of claim 1, further comprising:
determining, based on encoding the ultrasonic guided view-transformed BEV feature information, BEV feature information to generate BEV object information by distinguishing a BEV object using the BEV feature information; and
generating obstacle boundary information by detecting an obstacle boundary using the BEV feature information,
wherein the distinguishing of the BEV object comprises distinguishing the BEV object using the obstacle boundary information, and
wherein the detecting of the obstacle boundary comprises detecting the obstacle boundary using the BEV object information.

6. The method of claim 1, further comprising:
determining, based on encoding the ultrasonic guided view-transformed BEV feature information, BEV feature information to generate BEV object information by distinguishing a BEV object using the BEV feature information;
fusing the BEV object information with the BEV feature information; and
generating obstacle boundary information by detecting an obstacle boundary using the BEV feature information fused with the BEV object information.

7. The method of claim 1, further comprising:
generating, based on BEV segmentation information and obstacle-boundary information obtained from the fused BEV feature information, an occupancy map, wherein the occupancy map represents object-occupied regions and unoccupied regions in a surrounding environment of the vehicle,
obtaining, from the occupancy map, outline information of the object, and
performing, based on the outline information, interpolation on the ultrasonic data.

8. A vehicle comprising:
a sensor unit configured to detect a target object present in a surrounding environment of the vehicle during autonomous driving of the vehicle, wherein the sensor unit comprises a camera and an ultrasonic sensor;
a processor; and
a memory storing at least one instruction that, when executed by the processor, is configured to cause the vehicle to:
obtain, via the ultrasonic sensor, ultrasonic data,
generate, based on the ultrasonic data, ultrasonic feature information, obtain, via the camera, image data,
generate, based on the image data, image feature information,
perform, based on first depth information associated with the image feature information and second depth information associated with the ultrasonic data, a view transformation on the image feature information,
generate, using the view-transformed image feature information, ultrasonic guided view-transformed bird's-eye-view (BEV) feature information,
adjust, based on the image feature information, the ultrasonic feature information, wherein the image feature information comprises information on an object, generate, using the adjusted ultrasonic feature information, ultrasonic BEV feature information,
fuse the ultrasonic guided view-transformed BEV feature information with the ultrasonic BEV feature information to generate fused BEV feature information,
output, based on the fused BEV feature information, a signal indicating the object,
control, based on the signal, an operation of the vehicle.

9. The vehicle of claim 8, wherein the at least one instruction, when executed by the processor, is configured to cause the vehicle to:
estimate, based on the image feature information, a depth distribution,
perform, based on the estimated depth distribution, a view transformation on the image feature information to generate first BEV feature information,
determine, based on the ultrasonic data, the second depth information,
perform, based on the second depth information, a view transformation on the ultrasonic feature information to generate second BEV feature information, and
generate the ultrasonic guided view-transformed BEV feature information by fusing the first BEV feature information with the second BEV feature information.

10. The vehicle of claim 8, wherein the at least one instruction, when executed by the processor, is configured to cause the vehicle to:
determine a plurality of pieces of ultrasonic data detected via the ultrasonic sensor at different times,
perform compensation on each of the plurality of pieces of ultrasonic data with reference to one of the different times, and
accumulate the plurality of compensated pieces of ultrasonic data to generate the ultrasonic feature information.

11. The vehicle of claim 10, wherein the at least one instruction, when executed by the processor, is configured to cause the vehicle to:
determine, based on the image feature information including the object, the plurality of compensated pieces of ultrasonic data, and
adjust an area corresponding to the object that is included in the adjusted ultrasonic feature information.

12. The vehicle of claim 8, wherein the at least one instruction, when executed by the processor, is configured to cause the vehicle to:
determine, based on encoding the ultrasonic guided view-transformed BEV feature information, BEV feature information to generate BEV object information by distinguishing a BEV object using the BEV feature information, and
generate obstacle boundary information by detecting an obstacle boundary using the BEV feature information,
wherein the distinguishing of the BEV object comprises distinguishing the BEV object using the obstacle boundary information, and
wherein the detecting of the obstacle boundary comprises detecting the obstacle boundary using the BEV object information.

13. The vehicle of claim 8, wherein the at least one instruction, when executed by the processor, is configured to cause the vehicle to:
determine, based on encoding the ultrasonic guided view-transformed BEV feature information, BEV feature information to generate BEV object information by distinguishing a BEV object using the BEV feature information,
fuse the BEV object information with the BEV feature information, and
generate obstacle boundary information by detecting an obstacle boundary using the BEV feature information fused with the BEV object information.

14. The vehicle of claim 8, wherein the at least one instruction, when executed by the processor, is configured to cause the vehicle to:
generate, based on BEV segmentation information and obstacle-boundary information obtained from the fused BEV feature information, an occupancy map, wherein the occupancy map represents object-occupied regions and unoccupied regions in the surrounding environment of the vehicle,
obtain, from the occupancy map, outline information of the object, and
perform, based on the outline information, interpolation on the ultrasonic data.

15. A non-transitory computer-readable storage medium storing instructions, that, when executed, cause a vehicle to:
obtain, via an ultrasonic sensor, ultrasonic data,
generate, based on the ultrasonic data of the vehicle, ultrasonic feature information,
obtain, via a camera of the vehicle, image data,
generate, based on the image data, image feature information,
perform, based on first depth information associated with the image feature information and second depth information associated with the ultrasonic data, a view transformation on the image feature information,
generate, using the view-transformed image feature information, ultrasonic guided view-transformed bird's-eye-view (BEV) feature information,
adjust, based on the image feature information, the ultrasonic feature information, wherein the image feature information comprises information on an object,
generate, using the adjusted ultrasonic feature information, ultrasonic BEV feature information,
fuse the ultrasonic guided view-transformed BEV feature information with the ultrasonic BEV feature information to generate fused BEV feature information,
output, based on the fused BEV feature information, a signal indicating the object, and
control, based on the signal, autonomous driving of the vehicle.

16. The non-transitory computer-readable storage medium of claim 15, wherein the instructions, when executed, cause the vehicle to:
estimate, based on the image feature information, a depth distribution,
perform, based on the estimated depth distribution, a view transformation on the image feature information to generate first BEV feature information,
determine, based on the ultrasonic data, the second depth information,
perform, based on the second depth information, a view transformation on the ultrasonic feature information to generate second BEV feature information, and
generate the ultrasonic guided view-transformed BEV feature information by fusing the first BEV feature information with the second BEV feature information.

17. The non-transitory computer-readable storage medium of claim 15, wherein the instructions, when executed, cause the vehicle to:
determine a plurality of pieces of ultrasonic data detected via the ultrasonic sensor at different times;
perform compensation on each of the plurality of pieces of ultrasonic data with reference to one of the different times; and
accumulate the plurality of compensated pieces of ultrasonic data to generate the ultrasonic feature information.

18. The non-transitory computer-readable storage medium of claim 17,
wherein the accumulating of the plurality of compensated pieces of ultrasonic data is based on the image feature information including the object, and
wherein the generating of the ultrasonic BEV feature information comprises adjusting an area corresponding to the object that is included in the adjusted ultrasonic feature information.

19. The non-transitory computer-readable storage medium of claim 15, wherein the instructions, when executed, cause the vehicle to:
determine, based on encoding the ultrasonic guided view-transformed BEV feature information, BEV feature information to generate BEV object information by distinguishing a BEV object using the BEV feature information; and
generate obstacle boundary information by detecting an obstacle boundary using the BEV feature information,
wherein the distinguishing of the BEV object comprises distinguishing the BEV object using the obstacle boundary information, and
wherein the detecting of the obstacle boundary comprises detecting the obstacle boundary using the BEV object information.

20. The non-transitory computer-readable storage medium of claim 15, wherein the instructions, when executed, cause the vehicle to:
determine, based on encoding the ultrasonic guided view-transformed BEV feature information, BEV feature information to generate BEV object information by distinguishing a BEV object using the BEV feature information;
fuse the BEV object information with the BEV feature information; and
generate obstacle boundary information by detecting an obstacle boundary using the BEV feature information fused with the BEV object information.
